(19) United States
(12) Patent Application Publication
(10) Pub. No.: US 2004/0022899 A1
(43) Pub. Date: Feb. 5, 2004

(54) Method of manufacturing noodles or pasta

(76) Inventor: Chiu Tai Lai, Hong Kong (HK)

Correspondence Address: JACOBSON HOLMAN PLLC, 400 SEVENTH STREET N.W., SUITE 600, WASHINGTON, DC, 20004, US

(21) Appl. No.: 10/207,960

(22) Filed: Jul. 31, 2002

(51) Int. Cl. A23G 3/00

(52) U.S. Cl. 426/94

(57) ABSTRACT

This invention provides a method of manufacturing a noodle or pasta. The noodle or pasta is coaxially extruded with a core material of different composition. In doing so a noodle may be produced that has an inner meat or other core material and an outer lining of pasta or noodle. The noodles may be co-extruded and are allowed to dry ready for packaging. The invention also provides an apparatus involving coaxial nozzles communicating with chambers of the core and outer materials to produce the simultaneous extrusion.

### FIELD OF THE INVENTION

This invention relates to a method of manufacturing noodles or pasta and, in particular, elongate noodles or pasta having an outer layer and all interior filling.

### BACKGROUND TO THE INVENTION

A variety of noodles or pasta exists in the marketplace. Amongst these, some of the pasta utilize fillings with the pasta formed into some form of package containing the meat or other type of filling.

Elongate pasta such as spaghetti or noodles whether made from flour or rice are traditionally provided as elongate thin rods or strings of a singular uniform composition. It is desired to add elements to a dish containing such pasta or noodles, meat or other materials which generally provided within a sauce or similar to accompany the pasta or noodle. The pasta or noodle has no easy method of encapsulating additional materials such as fillings, flavourings or similar.

### OBJECT OF THE INVENTION

It is an object of the present invention to provide a method of manufacturing noodles or pasta that can provide an elongate form containing an exterior material and at least one interior material of different composition.

### SUMMARY OF THE INVENTION

Accordingly, in the first aspect, the invention may broadly be said to consist in a method of manufacturing noodles or pasta comprising:

extruding at least a first core material from a nozzle receiving a supply or such material; and

coaxially extruding an outer material about said core material from a nozzle receiving a supply of outer material.

Preferably said nozzle from which said core material is extruded fits into said nozzle or a chamber connected to said nozzle extruding said outer material.

Preferably said method further includes the initial step of formulating the core and outer material separately.

Preferably said core and outer materials are extruded through said nozzles under pressure.

Preferably said elongate noodles or pasta are allowed to dry following extrusion.

Preferably said outer material substantially encapsulates said core material.

Accordingly, in a second aspect, the invention may broadly be said to consist in a noodle or a pasta comprising an elongate segment of noodle or pasta produced by the method previously described.

Accordingly, in a third aspect, the invention may broadly be said to consist in a machine for the production of noodles or pasta comprising:

a chamber for containing a core material;

a first nozzle attached to said chamber for containing said core material;

pressurizing means to apply pressure to said chamber containing said core material to extrude core material from said nozzle;

a second chamber containing an outer material;

a second nozzle attached to said second chamber;

pressurizing means, attached to said second chamber to extrude outer material from said second nozzle; and

wherein said first nozzle extrudes said core material into the interior of said second nozzle or chamber so as to coaxially extrude a noodle or pasta having an outer material and at least one core material.

### BRIEF DESCRIPTION OF THE DRAWINGS

This invention will now be described with reference to preferred embodiments in which:

FIG. 1 shows a cross-sectional view through a noodle or pasta in accordance with a first embodiment of this invention; and

FIG. 2 shows a side cross-sectional elevation through an apparatus used in the process of manufacture of the item showing in the first embodiment.

### DETAILED DESCRIPTION OF PREFERRED EMBODIMENTS

This invention relates to; a noodle or pasta and, in particular, an elongate noodle or pasta. It should be noted that noodles or pasta are made from similar materials and are used as generic terms to describe elongate relatively small diameter foods made from variety of materials,

Typically noodles or pasta are made from forms of flour made from wheat, barley or even rice-based noodles. The terms may be used generally to describe the elongate products of this invention regardless of the particular composition. Other noodle materials such as corn and potato are also specifically included as are any similar base materials for noodle making.

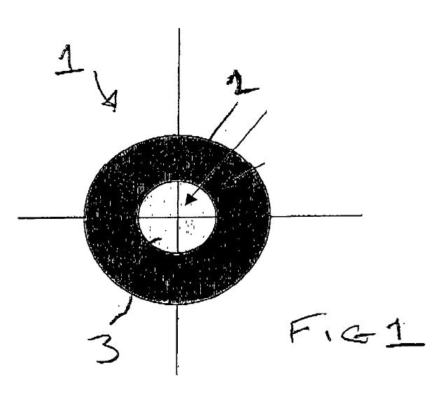

Referring to the drawings, a first embodiment of a noodle or pasta in accordance with the invention could be seen in cross-section in FIG. 1.

The noodle 1 can be seen to have an outer material 2 and an inner core material 3. Although shown as generally circular in cross-section in FIG. 1, the core material 3 and the outer layer 2 may be of any desired shape and do not necessarily need to match each other, It is generally intended that the outer layer 2 substantially surrounds the inner core material 3 although even this is not completely necessary, In other embodiments the core material could protrude through the outer layer in some places.

Generally this invention relates to an elongate noodle with the core material 3 be of a different composition than the outer material 2. Although any number of different core materials can be used, various meat, vegetable or fruit core materials might be particularly desirable. In particular, dehydrated meat products may be suitable as the noodles may be prepared for storage.

In this preferred embodiment and generally throughout the description, the core material 3 is referred to as being a single composition. Of course, it will be appreciated that the core material 3 could include a mixture of materials in discrete zones within the core including further concentric zones of material if desired.

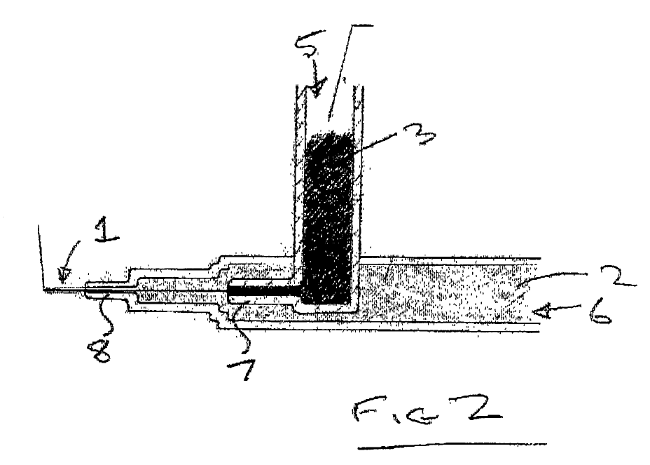

To manufacture the noodle 1, an apparatus as shown in FIG. 2 may be used.

As shown in FIG. 2, a first chamber 5 may be filled with a core material 3 to which a first nozzle 7 may be fitted. By applying pressure to the chamber 5, the core material 3 may be extruded from the nozzle 7.

The first nozzle 7 may be located substantially coaxially with a second nozzle 8 surrounding the first nozzle 7. An associated second chamber 6 may hold the outer material 2 and simultaneous application of pressure to the second chamber 6 may allow the resultant noodle 1 to be extruded from the nozzle 8 with the core material ready fit within the outer material,

Other apparatus could be used although it is generally intended that the method involves the simultaneous extrusion of the core material 3 and the outer material 2. It will also be appreciated that a further nozzle and chamber could fit within the first nozzle 7 so as to add an addition core material which, if desired, could be coaxial with the other materials 2 and 3.

The core material 3 and the outer material 2 may be formulated and prepared separately and fit to the chambers 5 and 6.

In extruding the materials, a variety of pressures may be applied depending on the nature, composition and consistency of the materials 2 and 3. In generals a relatively low pressure might be applied such as pressures in the range of 1 to 3 MPa. However, the pressures in the chambers 5 and 6 may be different from one and other as the intention is to create an equivalent rate of extrusion from the nozzles 7 and 8. Pressures may need to be adjusted as the consistency of the materials 2 and 3 changes for different basic materials or different batches. Ideally, the pressure applied to the clambers 5 and 6 can be independently controlled and adjusted as required should be determined that there is changing conditions or materials causing an inconsistent matching in the extrusion rates between the nozzles.

The noodle 1 extruded so as to have both the core material and the outer material together, the elongate noodles may then be dried prior to packaging. Typically drying may involve placement of the noodles in a low relative humidity environment and may or may not include maintaining an environment at an elevated temperature. Such noodles will satisfactorily dry at room temperature provided the relative humidity is low,

Thus it can be seen that the invention produces a noodle having all outer material and at least one inner core material or different composition. Elongate noodles of this type may allow We placement of meat, vegetables fruit or other constituents within a noodle prior to drying, packaging and preparation for market.

This invention has been described by way of preferred embodiments which should not be considered limiting to the scope of the invention as claimed. Specific integers referred to throughout the description are deemed to incorporate known equivalent where appropriate.

1. A method of manufacturing noodles or pasta comprising:
extruding at least a first core material from a nozzle receiving a supply or such material; and
coaxially extruding an outer material about said core material from a nozzle receiving a supply of outer material.

2. A method of manufacturing noodles or pasta as claimed in claim 1 wherein said nozzle from which said core material is exuded fits into said nozzle or a chamber connected to said nozzle extruding said outer material.

3. A method of manufacturing noodles or pasta as claimed in claim 1 wherein said method further includes the initial step of formulating the core and outer material separately.

4. A method of manufacturing noodles or pasta as claimed in claim 1 wherein said core and outer materials are extruded through said nozzles under pressure.

5. A method of manufacturing noodles or pasta as claimed in claim 1 wherein said clongate noodles or pasta are allowed to dry following extrusion.

6. A method of manufacturing noodles or pasta as claimed in claim 1 wherein said outer material substantially encapsulates said core material.

7. A noodle or a pasta comprising an elongate segment of noodle or pasta produced by the method as claimed in any one of claims 1-6.

8. A machine for the production of noodles or pasta comprising:
a chamber for containing a core material;
a first nozzle attached to said chamber for containing said core material;
pressurizing means to apply pressure to said chamber containing said core material to extrude core material from said nozzle;
a second chamber containing an outer material;
a second nozzle attached to said second clamber;
pressurizing means attached to m second chamber to extrude outer material from said second nozzle; and
wherein said first nozzle extrudes said core material into the interior of said second nozzle or chamber so as to coaxially extrude a noodle or pasta having an outer material and at least one core material.
